(19) United States
(12) Patent Application Publication
(10) Pub. No.: US 2012/0002297 A1
(43) Pub. Date: Jan. 5, 2012

(54) COLLIMATOR LENS

(76) Inventors: Hiroshi Kameda, Niigata-ken (JP); Shoichi Kyoya, Niigata-ken (JP); Masayoshi Nakagawa, Niigata-ken (JP); Yasuyuki Kondo, Niigata-ken (JP)

(21) Appl. No.: 13/230,468

(22) Filed: Sep. 12, 2011

Related U.S. Application Data
(63) Continuation of application No. PCT/JP2010/054337, filed on Mar. 15, 2010.

(30) Foreign Application Priority Data
Mar. 30, 2009 (JP) 2009-081276

(51) Int. Cl. G02B 27/30

(52) U.S. Cl. 359/641

(57) ABSTRACT

There is provided a collimator lens which turns light emitted from a laser device, which is used in a laser display device, into parallel beams. The collimator lens is configured such that the wavelength of the light from the laser device is equal to or longer than 375 nm and equal to or shorter than 750 nm, the numerical aperture is equal to or larger than 0.2 and equal to or smaller than 0.75, and both conditions of “D/f>0.85 assuming that the lens thickness is D and the focal distance is f” and “νd>57 assuming that the Abbe number is νd” are satisfied.

### CLAIM OF PRIORITY

This application is a Continuation of International Application No. PCT/JP2010/054337 filed on Mar. 15, 2010, which claims benefit of Japanese Patent Application No. 2009-081276 filed on Mar. 30, 2009. The entire contents of each of these applications noted above are hereby incorporated by reference in their entireties.

### BACKGROUND

1. Field of the Disclosure

The present disclosure relates to a collimator lens which turns light, which is emitted from a laser device in a laser display module, into parallel beams and in particular, to a collimator lens capable of suppressing a chromatic aberration against a variation in the wavelength of light.

2. Description of the Related Art

Light emitted from a laser device is diverging light. Accordingly, a collimator lens which turns diverging light into parallel beams when used in various apparatuses is known. Generally, the collimator lens is configured to include aspheric lenses on both surfaces.

A laser display device is known as a device in which a collimator lens is used. The laser display device includes a laser device, a collimator lens, an image generator, and a screen. Light emitted from the laser device is turned into parallel beams by the collimator lens, the parallel beams are incident on the image generator, the incident light branches into a plurality of light beams, and the branched light beams are projected on a screen. Then, the screen emits light at the projection positions of the branched light beams, and an image is generated by scanning the projection positions by the image generator.

In the laser display device, an output-variable laser device is used. Accordingly, the temperature increases when output is high. Since the wavelength of light emitted from the laser device changes when the temperature increases, the working distance (WD) of the collimator lens changes. In order to suppress a change (ΔWD) in the working distance to be low, it is necessary to improve the chromatic aberration characteristics of the collimator lens. As a technique for improving the chromatic aberration characteristics of a collimator lens, a collimator lens formed by a combination of a plurality of lenses is known, for example, as disclosed in Japanese Unexamined Patent Application Publication No. 2000-19388.

In the collimator lens formed by a combination of a plurality of lenses in order to improve the chromatic aberration characteristics, however, the number of components is increased. Accordingly, there is a problem in that the cost is high. In addition, in the case of a collimator lens formed by a single lens, it is common to form a lens thin. This is not suitable as a collimator lens for laser display, and the performance related to the chromatic aberration characteristics is also low.

### SUMMARY

There is provided a collimator lens which turns light emitted from a laser device, which is used in a laser display device, into parallel beams. The wavelength of the light from the laser device is equal to or longer than 375 nm and equal to or shorter than 750 nm. The numerical aperture is equal to or larger than 0.2 and equal to or smaller than 0.75. Both conditions of “D/f>0.85 assuming that the lens thickness is D and the focal distance is f” and “νd>57 assuming that the Abbe number is νd” are satisfied.

### BRIEF DESCRIPTION OF THE DRAWINGS

FIG. 1 shows an outline diagram of a laser display device using a collimator lens according to an embodiment;

FIG. 2 is a side view of the collimator lens;

FIG. 3 is a graph showing the relationship between the inverse number of the Abbe number νd and ΔWD/f;

FIG. 4 is a graph showing the relationship between D/f (D is the lens thickness) and ΔWD/Fig; and

FIG. 5 is a graph showing the relationship between R1/f (R1 is the paraxial radius of curvature of a collimator side lens) and ΔWD/f.

### DESCRIPTION OF THE EXEMPLARY EMBODIMENTS

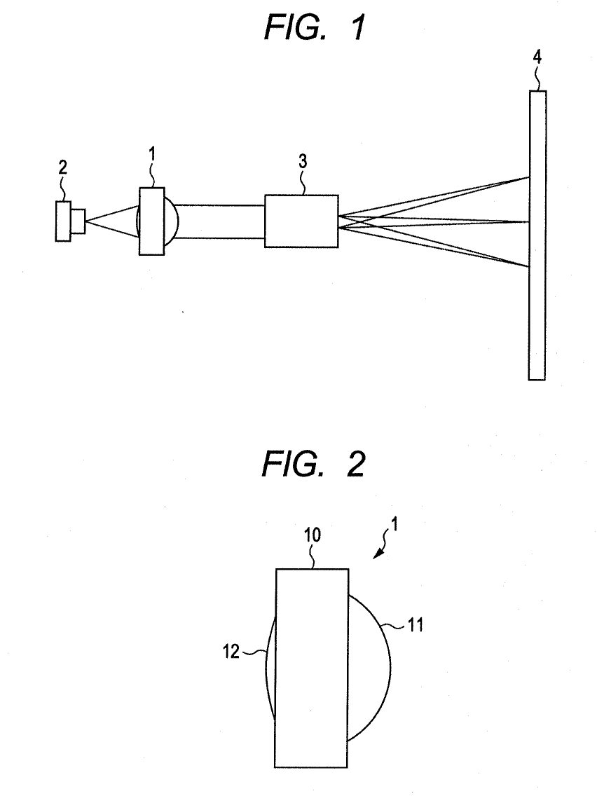

An embodiment of the present invention will be described in detail with reference to the accompanying drawings. FIG. 1 shows a schematic diagram of a laser display device using a collimator lens according to the present embodiment. The laser display device includes: a laser device 2 which emits light; a collimator lens 1 which turns light from the laser device 2 into parallel beams; an image generator 3 on which light beams turned into parallel beams by the collimator lens 1 are incident; and a screen 4 to which the light emitted from the image generator 3 is projected.

The wavelength of light emitted from the laser device 2 is 408 nm. However, if the output is increased, a wavelength variation occurs and the range is 408±10 nm. Assuming that a change in the working distance is ΔWD and the focal distance is fin the range of the wavelength variation, the collimator lens 1 according to the present embodiment is designed such that ΔWD/f<0.004 is satisfied.

The image generator 3 branches the incident light on the basis of an input signal and projects the branched light beams on the screen 4. The screen 4 is configured such that the projection position emits light when light is projected. It is possible to generate an image on the screen 4 by scanning the projection position on the screen 4 by the image generator 3.

The configuration of the collimator lens 1 will be described in more detail. FIG. 2 shows a side view of the collimator lens 1. The collimator lens 1 is formed of glass, and is configured to include a collimator side lens 11 and a light source side lens 12 on both surfaces of a base plate 10 formed by a circular or rectangular plate, respectively.

Both the collimator side lens 11 and the light source side lens 12 included in the collimator lens 1 have aspheric shapes. Surface data of each surface is shown in Tables 1 and 2. In addition, all units in Table 1 are “mm”.

TABLE 1
Surface data

| surface | | | | | effective |
|---|---|---|---|---|---|
| number | r | d | nd | vd | diameter |
| 1 | 2.91 | 4.50 | 1.59 | 61.2 | 4.80 |
| 2 | −6.17 | 4.50 | | | 4.80 |

TABLE 2
Aspheric surface data

| | | second |
|---|---|---|
| | first surface | surface |
| k | −6.14E−01 | 0.00E+00 |
| b4 | 3.55E−04 | 1.97E−02 |
| b6 | −7.42E−05 | −6.11E−03 |
| b8 | 2.32E−05 | 9.28E−04 |
| b10 | −5.38E−06 | 0.00E+00 |
| b12 | 2.93E−07 | 0.00E+00 |

In addition, various kinds of data regarding the collimator lens 1 are shown in Table 3.

TABLE 3

| | |
|---|---|
| designed wavelength (nm) | 408 |
| focal distance (mm) | 4.00 |
| numerical aperture | 0.60 |
| angle of view (mm) | 0.799 |
| image height (mm) | 0.0558 |
| lens thickness (mm) | 4.50 |
| outer diameter of lens (mm) | 6.33 |
| material of lens | L-BAL35 |

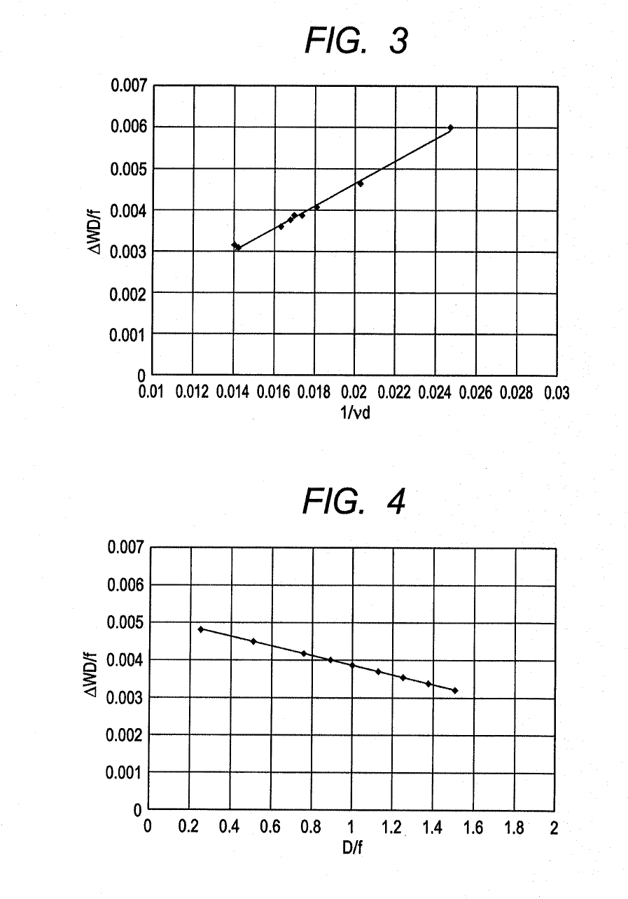

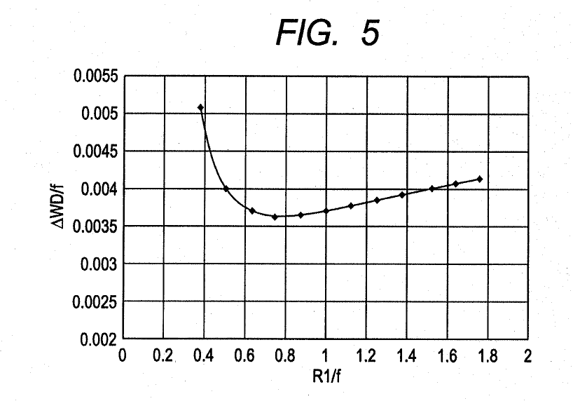

The characteristics when each parameter of the collimator lens 1 is changed will be described. FIG. 3 is a graph showing the relationship between the inverse number of the Abbe number νd and ΔWD/f. FIG. 4 is a graph showing the relationship between D/f (D is the lens thickness) and ΔWD/f. FIG. 5 is a graph showing the relationship between R1/f (R1 is the paraxial radius of the curvature of the collimator side lens 11) and ΔWD/f. The parameter conditions in each drawing are shown in Tables 4 to 6.

TABLE 4

| glass material | νd | f | D | r1 | r2 | nd | ΔWD/f |
|---|---|---|---|---|---|---|---|
| K-GFK70 | 71.3 | 4.00 | 4.50 | 2.94 | −4.90 | 1.57 | 0.00317 |
| K-PMK30 | 70.4 | 4.00 | 4.50 | 2.80 | −4.05 | 1.53 | 0.00311 |
| L-BAL35 | 61.2 | 4.00 | 4.50 | 3.02 | −5.37 | 1.59 | 0.00364 |
| K-VC79 | 57.9 | 4.00 | 4.50 | 3.09 | −5.88 | 1.61 | 0.00391 |
| K-VC78 | 55.4 | 4.00 | 4.50 | 3.27 | −7.76 | 1.67 | 0.00409 |
| L-LAM60 | 49.3 | 4.00 | 4.50 | 3.48 | −11.7 | 1.74 | 0.00469 |
| L-LAH84 | 40.4 | 4.00 | 4.50 | 3.66 | −18.8 | 1.81 | 0.600 |

TABLE 5

| glass material | νd | f | D | r1 | r2 | ΔWD/f |
|---|---|---|---|---|---|---|
| L-BAL35 | 61.2 | 4.00 | 1.00 | 3.015 | −10.7 | 0.00475 |
| L-BAL35 | 61.2 | 4.00 | 2.00 | 3.015 | −9.20 | 0.00444 |
| L-BAL35 | 61.2 | 4.00 | 3.00 | 3.015 | −7.67 | 0.00412 |
| L-BAL35 | 61.2 | 4.00 | 3.50 | 3.015 | −6.90 | 0.00396 |
| L-BAL35 | 61.2 | 4.00 | 4.00 | 3.015 | −6.13 | 0.00380 |
| L-BAL35 | 61.2 | 4.00 | 4.50 | 3.015 | −5.37 | 0.00364 |
| L-BAL35 | 61.2 | 4.00 | 5.00 | 3.015 | −4.60 | 0.00349 |
| L-BAL35 | 61.2 | 4.00 | 5.50 | 3.015 | −3.83 | 0.00333 |
| L-BAL35 | 61.2 | 4.00 | 6.00 | 3.015 | −3.07 | 0.00317 |

TABLE 6

| glass material | νd | f | D | r1 | r2 | ΔWD/f |
|---|---|---|---|---|---|---|
| L-BAL35 | 61.2 | 4.00 | 4.50 | 1.50 | −0.52 | 0.00510 |
| L-BAL35 | 61.2 | 4.00 | 4.50 | 2.01 | 1.85 | 0.00400 |
| L-BAL35 | 61.2 | 4.00 | 4.50 | 2.50 | −24.4 | 0.00370 |
| L-BAL35 | 61.2 | 4.00 | 4.50 | 3.00 | −5.44 | 0.00364 |
| L-BAL35 | 61.2 | 4.00 | 4.50 | 3.50 | −4.04 | 0.00367 |
| L-BAL35 | 61.2 | 4.00 | 4.50 | 4.00 | −3.53 | 0.00373 |
| L-BAL35 | 61.2 | 4.00 | 4.50 | 4.50 | −3.26 | 0.00380 |
| L-BAL35 | 61.2 | 4.00 | 4.50 | 5.00 | −3.10 | 0.00387 |
| L-BAL35 | 61.2 | 4.00 | 4.50 | 5.50 | −2.99 | 0.00393 |
| L-BAL35 | 61.2 | 4.00 | 4.50 | 6.03 | −2.91 | 0.00400 |
| L-BAL35 | 61.2 | 4.00 | 4.50 | 6.50 | −2.85 | 0.00405 |
| L-BAL35 | 61.2 | 4.00 | 4.50 | 7.00 | −2.80 | 0.00411 |

As shown in FIG. 3, ΔWD/f decreases as the inverse number of the Abbe number of the collimator lens 1 decreases, that is, as the Abbe number νd increases. The Abbe number satisfying ΔWD/f<0.004 is in the range of 1/νd<0.0175, that is, νd>57. Moreover, as shown in FIG. 4, in the relationship with the lens thickness D of the collimator lens 1, ΔWD/f decreases as D/f increases, that is, as the lens thickness increases. The conditions satisfying ΔWD/f<0.004 are the range of D/f>0.85. Moreover, as shown in FIG. 5, for the paraxial radius of the curvature R1 of the collimator side lens 11, ΔWD/f<0.004 is satisfied in the range of 0.51<R1/f<1.5.

From these results, in the present embodiment, the collimator side lens 11 is formed of a glass material with the Abbe number νd of 61.2 so as to have a thickness satisfying D/f of 1.13 and to have R1/f of 0.75. In this case, ΔWD/f is 0.00364 which is smaller than 0.004.

Thus, by setting the lens thickness D of the collimator lens 1 to be large and selecting a glass material such that the Abbe number νd becomes a proper value, a lens with good chromatic aberration characteristics can be formed even with a single lens. As a result, a collimator lens which is suitable for a laser display device can be realized at low cost.

While the embodiment of the present invention has been described, applications of the present invention are not limited to the present embodiment, and various applications may also be made within the technical scope of the present invention. For example, although the wavelength of light emitted from the laser device 2 is set to 408 nm, the present invention may also be applied within a range of 375 nm or more and 750 nm or less.

It should be understood by those skilled in the art that various modifications, combinations, sub-combinations, and alterations may occur depending on design requirements and other factors insofar as they are within the scope of the appended claims of the equivalents thereof.

What is claimed is:

1. A collimator lens which turns light emitted from a laser device, which is used in a laser display device, into parallel beams,
wherein the wavelength of the light from the laser device is equal to or longer than 375 nm and equal to or shorter than 750 nm,
wherein the numerical aperture is equal to or larger than 0.2 and equal to or smaller than 0.75, and
all of conditions of “D/f>0.85 assuming that the lens thickness is D and the focal distance is f”, “νd>57 assuming that the Abbe number is νd”, and “0.51<R1/f<1.5 wherein the paraxial radius of a lens surface formed at the collimator light side is R1” are satisfied.

2. The collimator lens according to claim 1, a change in the working distance (ΔWD) satisfies the condition ΔWD/f<0.004 using a single lens.
